(19) United States
(12) Patent Application Publication
(10) Pub. No.: US 2026/0262060 A1
(43) Pub. Date: Sep. 3, 2026

(54) METHOD FOR SENDING CYCLIC PREFIX EXTENSION (CPE), AND APPARATUS THEREFOR

(71) Applicant: Beijing Xiaomi Mobile Software Co., Ltd., Beijing (CN)

(72) Inventor: Wensu ZHAO

(73) Assignee: Beijing Xiaomi Mobile Software Co., Ltd., Beijing (CN)

(21) Appl. No.: 18/878,371

(22) PCT Filed: Jun. 30, 2022
(86) PCT No.: PCT/CN2022/103167

§ 371 Date: Dec. 23, 2024

(51) Int. Cl. H04W 72/25; H04L 27/26; H04W 74/0808

(52) U.S. Cl. CPC H04W 72/25; H04L 27/2678; H04W 74/0808

(57) ABSTRACT

Disclosed are a method for sending a Cyclic Prefix Extension (CPE), and an apparatus therefor. The method comprises: a first terminal sending a CPE to a second terminal before a first symbol of first information sent by the first terminal, wherein the first information is physical sidelink control channel (PSCCH) information, physical sidelink shared channel (PSSCH) information, or physical sidelink feedback channel (PSFCH) information.

### CROSS-REFERENCE

The present application is a U.S. National Stage of International Application No. PCT/CN2022/103167, filed on Jun. 30, 2022, the contents of which are incorporated herein by reference in its entirety for all purposes.

### TECHNICAL FIELD

The present disclosure relates to the field of communication technologies, and in particular to a method and apparatus for sending a Cyclic Prefix Extension (CPE).

### BACKGROUND

With the continuous emergence of new communication services and application requirements, terminal Sidelink (SL, also called direct link) communications have increasingly high requirements for transmission bandwidth, communication rate, communication delay, reliability, scalability and other performance, and limited licensed spectrums alone cannot meet diverse application scenarios and requirements in the future. At present, in the terminal sidelink communication on an unlicensed spectrum (sidelink-unlicensed, SL-U), in order to ensure that the data transmission is continuous, and the acquired channel is not occupied by a Wireless Fidelity (WIFI) device, a Cyclic Prefix Extension (CPE) is used to occupy the channel in advance.

### SUMMARY

Embodiments of the present disclosure provide a method and apparatus for sending a Cyclic Prefix Extension (CPE).

In a first aspect, embodiments of the present disclosure provide a method for sending a Cyclic Prefix Extension (CPE), which is performed by a first terminal device, and the method includes: sending the CPE to a second terminal device before a first symbol of first information sent by the first terminal device; wherein the first information is Physical Sidelink Control Channel (PSCCH) information, Physical Sidelink Shared Channel (PSSCH) information, or Physical Sidelink Feedback Channel (PSFCH) information.

‘In a second aspect, embodiments of the present disclosure provide a method for receiving a Cyclic Prefix Extension (CPE), which is performed by a second terminal device, and the method includes: receiving the CPE sent by a first terminal device before receiving a first symbol of first information of the first terminal device; wherein the first information is Physical Sidelink Control Channel (PSCCH) information, Physical Sidelink Shared Channel (PSSCH) information, or Physical Sidelink Feedback Channel (PSFCH) information.

In a third aspect, embodiments of the present disclosure provide a communication device, including a processor, and when the processor invokes a computer program in a memory, it executes the method described in the first aspect above.

In a fourth aspect, embodiments of the present disclosure provide a communication device, including a processor, and when the processor invokes a computer program in a memory, it executes the method described in the second aspect above.

In a fifth aspect, embodiments of the present disclosure provide a communication device, including a processor and a memory, and a computer program is stored in the memory; the processor executes the computer program stored in the memory, so that the communication device executes the method described in the first aspect above.

In a sixth aspect, embodiments of the present disclosure provide a communication device, including a processor and a memory, and a computer program is stored in the memory; the processor executes the computer program stored in the memory, so that the communication device executes the method described in the second aspect above.

In a seventh aspect, embodiments of the present disclosure provide a communication device, including a processor and an interface circuit, the interface circuit is configured to receive code instructions and send them to the processor, and the processor is configured to run the code instructions to cause the communication device to execute the method described in the first aspect above.

In an eighth aspect, embodiments of the present disclosure provide a communication device, including a processor and an interface circuit, the interface circuit is configured to receive code instructions and send them to the processor, and the processor is configured to run the code instructions to cause the communication device to execute the method described in the second aspect above.

In a ninth aspect, embodiments of the present disclosure provide a communication system, which includes the first terminal device described in the third aspect and the second terminal device described in the fourth aspect, or, the system includes the communication device described in the fifth aspect and the communication device described in the sixth aspect, or, the system includes the communication device described in the seventh aspect and the communication device described in the eighth aspect, or, the system includes the communication device described in the ninth aspect and the communication device described in the tenth aspect.

In a tenth aspect, embodiments of the present disclosure provide a computer-readable storage medium, which is configured to store instructions used by the above-mentioned terminal device, and the instructions, when executed, cause the terminal device to execute the method described in the above-mentioned first aspect.

In a eleventh aspect, embodiments of the present disclosure provide a computer-readable storage medium, which is configured to store instructions used by the above-mentioned terminal device, and the instructions, when executed, cause the terminal device to execute the method described in the above-mentioned second aspect.

In a twelfth aspect, the present disclosure further provides a computer program product including a computer program, which, when run on a computer, causes the computer to execute the method described in the above-mentioned first aspect.

In a thirteenth aspect, the present disclosure further provides a computer program product including a computer program, which, when run on a computer, causes the computer to execute the method described in the above-mentioned second aspect.

In a fourteenth aspect, the present disclosure provides a chip system, including at least one processor and an interface, and configured to support the terminal device to implement the functions involved in the first aspect, for example, determine or process at least one of data or information involved in the above method. In a possible design, the chip system further includes a memory, and the memory is configured to store necessary computer programs and data of the terminal device. The chip system may consist of chips, or may include a chip and other discrete device(s).

In a fifteenth aspect, the present disclosure provides a chip system, including at least one processor and an interface, and configured to support the terminal device to implement the functions involved in the second aspect, for example, determine or process at least one of data or information involved in the above method. In a possible design, the chip system further includes a memory, and the memory is configured to store necessary computer programs and data of the terminal device. The chip system may consist of chips, or may include a chip and other discrete device(s).

In a sixteenth aspect, the present disclosure provides a computer program which, when run on a computer, causes the computer to execute the method described in the first aspect above.

In a seventeenth aspect, the present disclosure provides a computer program which, when run on a computer, causes the computer to execute the method described in the second aspect above.

### BRIEF DESCRIPTION OF THE DRAWINGS

In order to more clearly illustrate the technical solutions in the embodiments of the present disclosure or the background, the following will describe the drawings that need to be used in the embodiments of the present disclosure or the background.

FIG. 1 is a schematic diagram of an architecture of a communication system provided in an embodiment of the present disclosure;

FIG. 2 is a schematic flowchart of a method for sending a Cyclic Prefix Extension (CPE) provided in an embodiment of the present disclosure;

FIG. 3 is a schematic flowchart of another method for sending a Cyclic Prefix Extension (CPE) provided in an embodiment of the present disclosure;

FIG. 4 is an example diagram of a first terminal device sending a CPE before a first symbol of the sent PSCCH information or PSSCH information;

FIG. 5 is a schematic flowchart of another method for sending a Cyclic Prefix Extension (CPE) provided in an embodiment of the present disclosure;

FIG. 6 is an example diagram of a first terminal device sending a CPE before a first symbol of the sent PSFCH information;

FIG. 7 is a schematic flowchart of another method for sending a Cyclic Prefix Extension (CPE) provided in an embodiment of the present disclosure;

FIG. 8 is an example diagram of a first terminal device sending a CPE before sending a first symbol of PSCCH information or PSSCH information when the first terminal device shares a COT initiated by a third terminal device;

FIG. 9 is a schematic flowchart of another method for sending a Cyclic Prefix Extension (CPE) provided in an embodiment of the present disclosure;

FIG. 10 is an example diagram of a first terminal device sending a CPE before sending a first symbol of PSFCH information when the first terminal device shares a COT initiated by a third terminal device;

FIG. 11 is a schematic flowchart of a method for receiving a Cyclic Prefix Extension (CPE) provided in an embodiment of the present disclosure;

FIG. 12 is a schematic structural diagram of a first terminal device provided in an embodiment of the present disclosure;

FIG. 13 is a schematic structural diagram of a second terminal device provided in an embodiment of the present disclosure;

FIG. 14 is a schematic structural diagram of a communication device provided in an embodiment of the present disclosure; and

FIG. 15 is a schematic structural diagram of a chip provided in an embodiment of the present disclosure.

### DETAILED DESCRIPTION

Embodiments of the present disclosure are described in detail below, examples of which are illustrated in the accompanying drawings, where the same or similar reference numerals throughout represent the same or similar elements or elements having the same or similar functions. The embodiments described below with reference to the accompanying drawings are illustrative and intended to explain the present disclosure and are not to be construed as limitations of the present disclosure. In the description of the present disclosure, unless otherwise stated, “/” means “or”. For example, A/B may mean A or B. The expression “and/or” herein is just an association relationship describing associated objects, and means that three relationships may exist. For example, A and/or B may mean: A exists alone, A and B exist at the same time, and B exists alone.

In order to better understand a method for sending a Cyclic Prefix Extension (CPE) disclosed in embodiments of the present disclosure, the communication system to which the embodiment of the present disclosure is applicable is first described below.

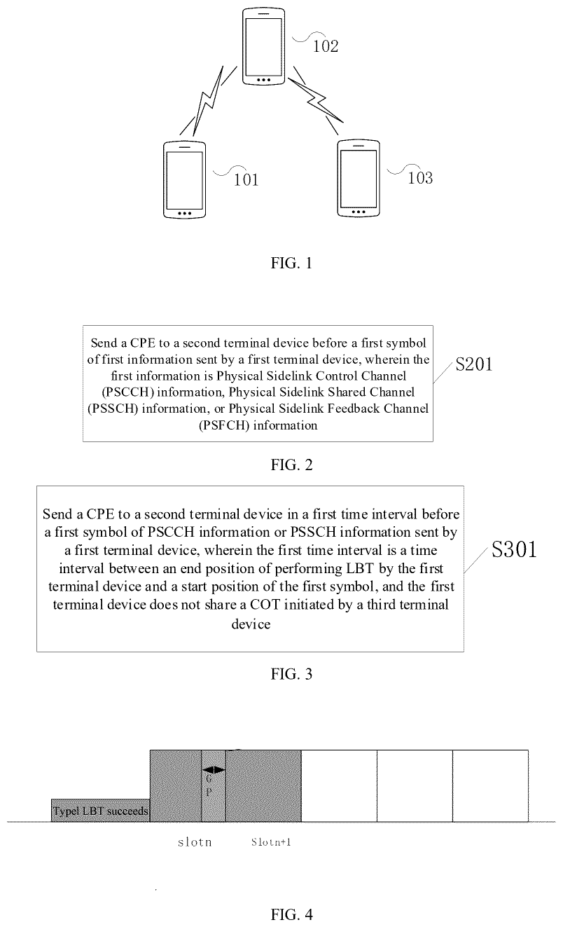

Please refer to FIG. 1, which is a schematic diagram of an architecture of a communication system provided in an embodiment of the present disclosure. The communication system may include but is not limited to three terminal devices, and the terminal devices communicate with each other via Sidelink. The number and form of devices shown in FIG. 1 are only used for example and do not constitute a limitation on embodiments of the present disclosure. The communication system shown in FIG. 1 includes a first terminal device 101, a second terminal device 102, and a third terminal device 103 as an example.

In embodiments of the present disclosure, the first terminal device 101, the second terminal device 102 and the third terminal device 103 can be respectively an entity on the user side for receiving or transmitting signals, such as a mobile phone. The terminal device may also be called a terminal, a user equipment (UE), a mobile station (MS), a mobile terminal (MT) and so on. The terminal device may be a car with communication functions, a smart car, a mobile phone, a wearable device, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present disclosure do not limit the specific technology and specific device form adopted by the terminal device.

It can be understood that the communication system described in the embodiments of the present disclosure is to illustrate the technical solutions of the embodiments of the present disclosure more clearly, and does not constitute a limitation to the technical solutions provided in the embodiments of the present disclosure. The person skilled in the art may know that with the evolution of the system architecture and the emergence of new service scenarios, the technical solutions provided in the embodiments of the present disclosure are also applicable to similar technical problems.

With the continuous emergence of new communication services and application requirements, terminal Sidelink (SL, also called direct link) communications have increasingly high requirements for transmission bandwidth, communication rate, communication delay, reliability, scalability and other performance, and limited licensed spectrums alone cannot meet diverse application scenarios and requirements in the future. At present, in the terminal sidelink communication on an unlicensed spectrum (sidelink-unlicensed, SL-U), in order to ensure that the data transmission is continuous, and the acquired channel is not occupied by a Wireless Fidelity (WIFI) device, a Cyclic Prefix Extension (CPE) is used to occupy the channel in advance, but there is a lack of specific implementation of the use of the CPE.

The following is a detailed introduction to a method and apparatus for sending a Cyclic Prefix Extension (CPE) provided by the present disclosure in conjunction with the accompanying drawings.

Please refer to FIG. 2, which is a schematic flowchart of a method for sending a Cyclic Prefix Extension (CPE) provided in an embodiment of the present disclosure. It should be noted that the method for sending the Cyclic Prefix Extension (CPE) in embodiments of the present disclosure can be performed by a first terminal device, and the first terminal device can be any terminal device. As shown in FIG. 2, the method for sending the Cyclic Prefix Extension (CPE) may include but is not limited to the following steps.

In step S201, the CPE is sent to a second terminal device before a first symbol of first information sent by the first terminal device; and the first information is Physical Sidelink Control Channel (PSCCH) information, Physical Sidelink Shared Channel (PSSCH) information, or Physical Sidelink Feedback Channel (PSFCH) information.

In some embodiments of the present disclosure, the first terminal device does not share a Channel Occupation Time (COT) initiated by a third terminal device. In an example, the first terminal device initiates the COT and does not share it with other terminal devices. In another example, the first terminal device initiates the COT and shares it with other terminal devices.

In a case where the first terminal device does not share the Channel Occupation Time (COT) initiated by the third terminal device, the first terminal device uses a period of channel occupation time alone; or during the channel occupation time, no other terminal device sends or receives information before the first terminal device sends the first information. In a case where the first terminal device initiates the COT and does not share it with other terminal devices, the first terminal device uses a period of channel occupation time alone. In a case where the first terminal device initiates the COT and shares it with other terminal devices, during the channel occupation time, no other terminal device sends or receives information before the first terminal device sends the first information.

The channel occupation time may be a period of channel occupation time initiated by the first terminal device after performing type1 LBT. Due to the existing R16/R17 sidelink slot structure, information can only be sent from a start symbol of a slot. Therefore, there is a time interval (for example, a gap symbol) between an end position of the first terminal device performing the LBT and a start position of the first information of the first terminal device, and this time interval is used to send the CPE, which can ensure the continuity of information transmission during the channel occupation time.

In a case where the first terminal device sends or receives information, there will be a time interval between the end position of sending the information and the start position of receiving the information. This time interval is used to send the CPE, which can ensure the continuity of information transmission during the channel occupation time.

In some other embodiments, the first terminal device shares the Channel Occupation Time (COT) initiated by the third terminal device, and the third terminal device initiates the COT after performing type1 LBT.

In a case where the first terminal device shares the Channel Occupation Time (COT) initiated by the third terminal device, the first terminal device and the third terminal device share a period of channel occupation time; or, the first terminal device, the third terminal device and other terminal devices sharing the COT initiated by the third terminal device share a period of channel occupation time.

In a case where different terminal devices use a certain period of time to send information during the channel occupation time, there will be a time interval between positions of the information of different terminal devices, and the CPE needs to be sent to ensure the continuity of information transmission during the channel occupation time. For example, after the information of the third terminal device is sent, the information of the first terminal device is sent, and there is a time interval between an end position of the information of the third terminal device and a start position of the information of the first terminal device. This time interval is used to send the CPE, which can ensure the continuity of information transmission during the channel occupation time. The information sent by the first terminal device and the information sent by the third terminal device may be the same or different.

In the method for sending the Cyclic Prefix Extension (CPE) in embodiments of the present disclosure, the first terminal device sends the CPE to the second terminal device before the first symbol of the sent first information, and the first information is the Physical Sidelink Control Channel (PSCCH) information, the Physical Sidelink Shared Channel (PSSCH) information, or the Physical Sidelink Feedback Channel (PSFCH) information, thereby ensuring that there is no idle time interval in the channel occupation time and ensuring the continuity of information transmission in the channel occupation time.

It should be noted that the above-mentioned implementations can be executed alone or in combination, which is not limited by embodiments of the present disclosure.

Please refer to FIG. 3, which is a schematic flowchart of another method for sending a Cyclic Prefix Extension (CPE) provided in an embodiment of the present disclosure. It should be noted that the method for sending the Cyclic Prefix Extension (CPE) in embodiments of the present disclosure can be performed by a first terminal device, and the first terminal device can be any terminal device that does not share a Channel Occupation Time (COT) initiated by a third terminal device. The third terminal device is any terminal device other than the first terminal device.

The method for sending the Cyclic Prefix Extension (CPE) can be executed alone, or can be executed in combination with any embodiment in the present disclosure or an implementation in the embodiment, or can be executed in combination with any technical solution in the related arts.

As shown in FIG. 3, the method for sending the Cyclic Prefix Extension (CPE) may include but is not limited to the following steps.

In step S301, the CPE is sent to a second terminal device in a first time interval before a first symbol of PSCCH information or PSSCH information sent by the first terminal device, the first time interval is a time interval between an end position of performing LBT by the first terminal device and a start position of the first symbol, and the first terminal device does not share a COT initiated by a third terminal device.

In embodiments of the present disclosure, in a case where the first terminal device does not share the Channel Occupation Time (COT) initiated by the third terminal device, the first terminal device uses a period of channel occupation time alone; or during the channel occupation time, no other terminal device sends or receives information before the first terminal device sends the first information. In a case where the first terminal device initiates the COT and does not share it with other terminal devices, the first terminal device uses a period of channel occupation time alone. In a case where the first terminal device initiates the COT and shares it with other terminal devices, during the channel occupation time, no other terminal device sends or receives information before the first terminal device sends the first information.

The channel occupation time may be a period of channel occupation time initiated by the first terminal device after performing type1 LBT. Due to the existing R16/R17 sidelink slot structure, information can only be sent from a start symbol of a slot. Therefore, there is a time interval (for example, a gap symbol) between an end position of the first terminal device performing the LBT and a start position of the first information of the first terminal device, and this time interval is used to send the CPE, which can ensure the continuity of information transmission during the channel occupation time.

A first symbol of the Physical Sidelink Control Channel (PSCCH) information or the Physical Sidelink Shared Channel (PSSCH) information may be, for example, an AGC symbol. It should be noted that the PSCCH information and the PSSCH information are sent using different subcarriers or the same subcarrier on the same channel, so the first symbols of the PSCCH information and the PSSCH information are the same.

As shown in FIG. 4, it is an example diagram of a first terminal device sending a CPE before a first symbol of the sent PSCCH information or PSSCH information. In FIG. 4, the first symbol of the PSCCH information or the PSSCH information sent by the first terminal device is the AGC symbol, which is located at a start position of slot Slotn+1 in FIG. 4. In FIG. 4, the first terminal device performs Type1 LBT, and an end position after the success of LBT is the later position in slot Slotn. The first time interval between the end position of the LBT of the first terminal device and the start position of the first symbol is shown as GP in FIG. 4. Then, before the first symbol of the PSCCH information or the PSSCH information, the first terminal device can initiate the CPE first and occupy the first time interval to send the CPE. When the start position of slot Slotn+1 is reached, the PSCCH information or the PSSCH information is sent.

In the method for sending the Cyclic Prefix Extension (CPE) in embodiments of the present disclosure, the first terminal device sends the CPE to the second terminal device in the first time interval before the first symbol of the sent PSCCH information or PSSCH information, the first time interval is the time interval between the end position of performing LBT by the first terminal device and the start position of the first symbol, and the first terminal device does not share the COT initiated by the third terminal device, thereby ensuring that there is no idle time interval in the channel occupation time, and ensuring the continuity of information transmission in the channel occupation time.

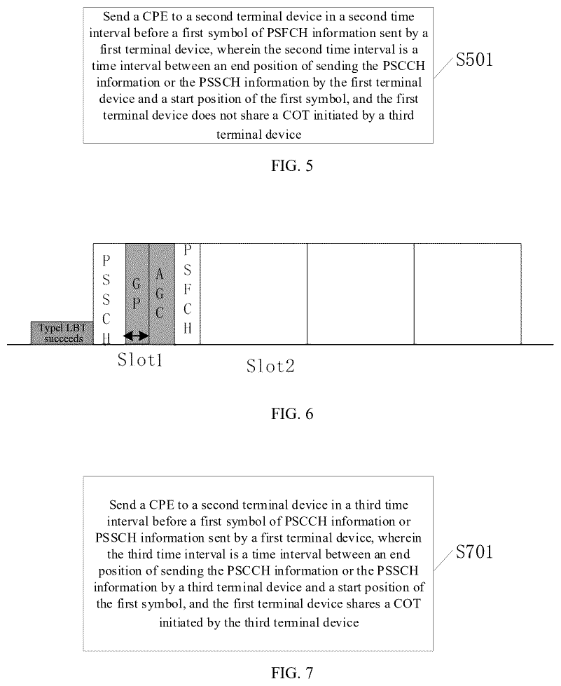

Please refer to FIG. 5, which is a schematic flowchart of another method for sending a Cyclic Prefix Extension (CPE) provided in an embodiment of the present disclosure. It should be noted that the method for sending the Cyclic Prefix Extension (CPE) in embodiments of the present disclosure can be performed by a first terminal device, and the first terminal device can be any terminal device that does not share a Channel Occupation Time (COT) initiated by a third terminal device.

The method for sending the Cyclic Prefix Extension (CPE) can be executed alone, or can be executed in combination with any embodiment in the present disclosure or an implementation in the embodiment, or can be executed in combination with any technical solution in the related arts.

As shown in FIG. 5, the method for sending the Cyclic Prefix Extension (CPE) may include but is not limited to the following steps.

In step S501, the CPE is sent to a second terminal device in a second time interval before a first symbol of PSFCH information sent by the first terminal device, the second time interval is a time interval between an end position of sending the PSCCH information or the PSSCH information by the first terminal device and a start position of the first symbol, and the first terminal device does not share a COT initiated by a third terminal device.

In embodiments of the present disclosure, in a case where the first terminal device does not share the Channel Occupation Time (COT) initiated by the third terminal device, the first terminal device uses a period of channel occupation time alone; or during the channel occupation time, no other terminal device sends or receives information before the first terminal device sends the first information. In a case where the first terminal device initiates the COT and does not share it with other terminal devices, the first terminal device uses a period of channel occupation time alone. In a case where the first terminal device initiates the COT and shares it with other terminal devices, during the channel occupation time, no other terminal device sends or receives information before the first terminal device sends the first information.

The channel occupation time may be a period of channel occupation time initiated by the first terminal device after performing type1 LBT. In a case where the first terminal device sends or receives information during the channel occupation time, there will be a time interval between an end position of sending the information (for example, the PSCCH information or the PSSCH information) and a start position of receiving the information, that is, the second time interval. The first terminal device sends the CPE to the second terminal device in the second time interval, which can ensure the continuity of information transmission during the channel occupation time. The sent information and the received information may be different information. The received information may be, for example, the Physical Sidelink Feedback Channel (PSFCH) information.

As shown in FIG. 6, it is an example diagram of a first terminal device sending a CPE before a first symbol of the sent PSFCH information. In FIG. 6, the first symbol of the PSFCH information sent by the first terminal device is the AGC symbol, as shown as AGC in Slot1 in FIG. 6. The end position of the PSCCH information or the PSSCH information sent by the first terminal device is shown as an end position of the PSSCH in Slot1 in FIG. 6. The second time interval between the end position of the PSCCH information or the PSSCH information sent by the first terminal device and the start position of the first symbol is shown as GP in FIG. 6. Then, after the end position of the PSCCH information or the PSSCH information and before the first symbol of the PSFCH information, the first terminal device can initiate the CPE first and occupy the second time interval to send the CPE. When a position where the AGC is located in Slot1 is reached, the PSFCH information is sent.

In the method for sending the Cyclic Prefix Extension (CPE) in embodiments of the present disclosure, the first terminal device sends the CPE to the second terminal device in the second time interval before the first symbol of the sent PSFCH information, the second time interval is the time interval between the end position of sending the PSCCH information or the PSSCH information by the first terminal device and the start position of the first symbol, and the first terminal device does not share the COT initiated by the third terminal device, thereby ensuring that there is no idle time interval in the channel occupation time and ensuring the continuity of information transmission in the channel occupation time.

Please refer to FIG. 7, which is a schematic flowchart of another method for sending a Cyclic Prefix Extension (CPE) provided in an embodiment of the present disclosure. It should be noted that the method for sending the Cyclic Prefix Extension (CPE) in embodiments of the present disclosure can be performed by a first terminal device, and the first terminal device can be any terminal device that shares a Channel Occupation Time (COT) initiated by a third terminal device. The third terminal device is a terminal device other than the first terminal device, and the third terminal device initiates the COT after performing type1 LBT.

The method for sending the Cyclic Prefix Extension (CPE) can be executed alone, or can be executed in combination with any embodiment in the present disclosure or an implementation in the embodiment, or can be executed in combination with any technical solution in the related arts.

As shown in FIG. 7, the method for sending the Cyclic Prefix Extension (CPE) may include but is not limited to the following steps.

In step S701, the CPE is sent to a second terminal device in a third time interval before a first symbol of PSCCH information or PSSCH information sent by the first terminal device, the third time interval is a time interval between an end position of sending the PSCCH information or the PSSCH information by the third terminal device and a start position of the first symbol, and the first terminal device shares the COT initiated by the third terminal device.

In embodiments of the present disclosure, in a case where the first terminal device shares the Channel Occupation Time (COT) initiated by the third terminal device, the first terminal device and the third terminal device share a period of channel occupation time; or, the first terminal device, the third terminal device and other terminal devices sharing the COT initiated by the third terminal device share a period of channel occupation time.

In a case where different terminal devices use a certain period of time to send information during the channel occupation time, there will be a time interval between positions of the information of different terminal devices, and the CPE needs to be sent to ensure the continuity of information transmission during the channel occupation time. For example, after the information of the third terminal device is sent, the information of the first terminal device is sent, and there is a time interval between an end position of the information of the third terminal device and a start position of the information of the first terminal device, that is, the third time interval. The first terminal device sends the CPE in the third time interval, which can ensure the continuity of information transmission during the channel occupation time. The information of the first terminal device and the information of the third terminal device can be the same.

The information of the third terminal device and the information of the first terminal device may be the PSCCH information or the PSSCH information.

If the third terminal device initiates the COT after performing type1 LBT, the third time interval needs to meet a specific value, such as 16 us. If the third terminal device initiates the COT after performing type2 LBT, the third time interval needs to meet a specific value, such as 25 us. The type2 LBT includes type2A LBT, type2B LBT, type2C LBT, etc.

It should be noted that, during the channel occupation time, before the information of the first terminal device is sent, the information of the third terminal device may be sent, or the information of other terminal devices may be sent. For example, other terminal devices may be any terminal device other than the first terminal device that shares the COT initiated by the third terminal device.

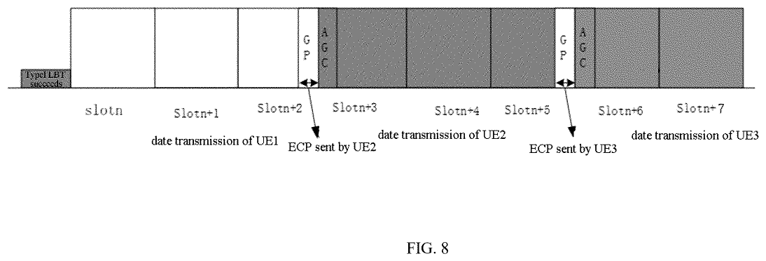

As shown in FIG. 8, it is an example diagram of a first terminal device sending a CPE before sending a first symbol of PSCCH information or PSSCH information when the first terminal device shares a COT initiated by a third terminal device. In FIG. 8, the third terminal device initiating the COT may be UE1, and the first terminal device may be UE2 or UE3.

In FIG. 8, taking the first terminal device as UE2 as an example, UE2 determines, according to the type of LBT specified by UE1, such as type2A, type2B, type2C, etc., that the third time interval between the end position of UE1's information and the start position of UE2's information needs to meet a specific value, such as 25 us. The third time interval is shown as GP in Slotn+2 in FIG. 8. UE2 needs to send the CPE in the third time interval until the start position of the UE2's information is reached. The information of UE1 and the information of UE2 can be the PSCCH information or the PSSCH information. The first symbol of the start position of UE2's information can be, for example, the AGC symbol.

In FIG. 8, taking the first terminal device as UE3 as an example, there is the third time interval between the end position of UE2's information and the start position of UE3's information. The third time interval is shown as GP in Slotn+5 in FIG. 8. UE3 needs to send the CPE in the third time interval until the start position of the UE3's information is reached. The information of UE2 and the information of UE3 can be the PSCCH information or the PSSCH information. The first symbol of the start position of the UE3's information can be, for example, the AGC symbol.

In the method for sending the Cyclic Prefix Extension (CPE) in embodiments of the present disclosure, the first terminal device sends the CPE to the second terminal device in the third time interval before the first symbol of the sent PSCCH information or PSSCH information, the third time interval is the time interval between the end position of sending the PSCCH information or the PSSCH information by the third terminal device and the start position of the first symbol, and the first terminal device shares the COT initiated by the third terminal device, thereby ensuring that there is no idle time interval in the channel occupation time and ensuring the continuity of information transmission in the channel occupation time.

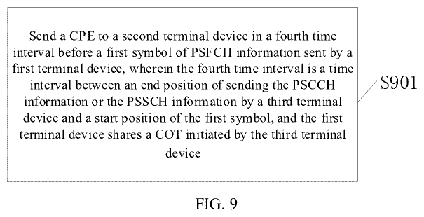

Please refer to FIG. 9, which is a schematic flowchart of another method for sending a Cyclic Prefix Extension (CPE) provided in an embodiment of the present disclosure. It should be noted that the method for sending the Cyclic Prefix Extension (CPE) in embodiments of the present disclosure can be applied to a first terminal device, and the first terminal device can be any terminal device that shares a Channel Occupation Time (COT) initiated by a third terminal device. The third terminal device is a terminal device other than the first terminal device, and the third terminal device initiates the COT after performing type1 LBT.

The method for sending the Cyclic Prefix Extension (CPE) can be executed alone, or can be executed in combination with any embodiment in the present disclosure or an implementation in the embodiment, or can be executed in combination with any technical solution in the related arts.

As shown in FIG. 9, the method for sending the Cyclic Prefix Extension (CPE) may include but is not limited to the following steps.

In step S901, the CPE is sent to a second terminal device in a fourth time interval before a first symbol of PSFCH information sent by the first terminal device, the fourth time interval is a time interval between an end position of sending the PSCCH information or the PSSCH information by a third terminal device and a start position of the first symbol, and the first terminal device shares a COT initiated by the third terminal device.

In embodiments of the present disclosure, in a case where the first terminal device shares the Channel Occupation Time (COT) initiated by the third terminal device, the first terminal device and the third terminal device share a period of channel occupation time; or, the first terminal device, the third terminal device and other terminal devices sharing the COT initiated by the third terminal device share a period of channel occupation time.

In a case where different terminal devices use a certain period of time to send information during the channel occupation time, there will be a time interval between positions of the information of different terminal devices, and the CPE needs to be sent to ensure the continuity of information transmission during the channel occupation time. For example, after the information of the third terminal device is sent, the information of the first terminal device is sent, and there is a time interval between an end position of the information of the third terminal device and a start position of the information of the first terminal device, that is, the fourth time interval. The first terminal device sends the CPE in the fourth time interval, which can ensure the continuity of information transmission during the channel occupation time. The information of the first terminal device and the information of the third terminal device can be different.

The information of the third terminal device may be the PSCCH information or the PSSCH information, and the information of the first terminal device may be the PSFCH information.

It should be noted that, during the channel occupation time, before the information of the first terminal device is sent, the information of the third terminal device may be sent, or the information of other terminal devices may be sent. For example, other terminal devices may be any terminal device other than the first terminal device that shares the COT initiated by the third terminal device.

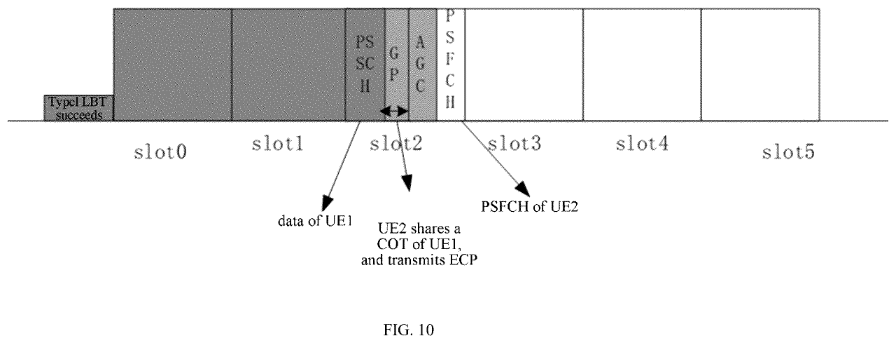

As shown in FIG. 10, it is an example diagram of a first terminal device sending a CPE before sending a first symbol of PSFCH information when the first terminal device shares a COT initiated by a third terminal device. In FIG. 10, the third terminal device initiating the COT may be UE1, and the first terminal device may be UE2. In FIG. 10, UE1 sends the information on slot0 to slot2. A PSFCH resource is configured on slot2, and UE2 needs to send the PSFCH information on the PSFCH resource configured on slot2. Then, there is the fourth time interval between the end position of UE1's information and the start position of UE2's PSFCH information, as shown as GP in FIG. 10. UE2 needs to send the Cyclic Prefix Extension in the fourth time interval until the start position of UE2's PSFCH information is reached. The UE1's information may be the PSCCH information or the PSSCH information. The first symbol at the start position of the UE2's PSFCH information may be, for example, the AGC symbol.

In the method for sending the Cyclic Prefix Extension (CPE) in embodiments of the present disclosure, the first terminal device sends the CPE to the second terminal device in the fourth time interval before the first symbol of the PSFCH information sent by the first terminal device, the fourth time interval is the time interval between the end position of sending the PSCCH information or the PSSCH information by the third terminal device and the start position of the first symbol, and the first terminal device shares the COT initiated by the third terminal device, thereby ensuring that there is no idle time interval in the channel occupation time and ensuring the continuity of information transmission in the channel occupation time.

Please refer to FIG. 11, which is a schematic flowchart of a method for receiving a Cyclic Prefix Extension (CPE) provided in an embodiment of the present disclosure. It should be noted that the method for receiving the Cyclic Prefix Extension (CPE) in embodiments of the present disclosure can be performed by a second terminal device, and the second terminal device is a terminal device that communicates with a first terminal device. As shown in FIG. 11, the method for receiving the Cyclic Prefix Extension (CPE) may include but is not limited to the following steps.

In step S1101, the CPE sent by a first terminal device is received before receiving a first symbol of first information of the first terminal device, and the first information is Physical Sidelink Control Channel (PSCCH) information, Physical Sidelink Shared Channel (PSSCH) information, or Physical Sidelink Feedback Channel (PSFCH) information.

In some embodiments of the present disclosure, the first terminal device does not share a Channel Occupation Time (COT) initiated by a third terminal device. In an example, the first terminal device initiates the COT and does not share it with other terminal devices. In another example, the first terminal device initiates the COT and shares it with other terminal devices.

In a case where the first terminal device does not share the Channel Occupation Time (COT) initiated by the third terminal device, the first terminal device uses a period of channel occupation time alone; or during the channel occupation time, no other terminal device sends or receives information before the first terminal device sends the first information. In a case where the first terminal device initiates the COT and does not share it with other terminal devices, the first terminal device uses a period of channel occupation time alone. In a case where the first terminal device initiates the COT and shares it with other terminal devices, during the channel occupation time, no other terminal device sends or receives information before the first terminal device sends the first information.

In a case where the first terminal device does not share a Channel Occupation Time (COT) initiated by a third terminal device, in an example, the first information is the PSCCH information or the PSSCH information. Correspondingly, the process of the second terminal device executing the step S1101 may be, for example, receiving the CPE in a first time interval before receiving the first symbol of the first information of the first terminal device, and the first time interval is a time interval between an end position of performing LBT by the first terminal device and a start position of the first symbol.

In another example, the first information is the PSFCH information. Correspondingly, the process of the second terminal device executing the step S1101 may be, for example, receiving the CPE in a second time interval before receiving the first symbol of the first information of the first terminal device, and the second time interval is a time interval between an end position of sending the PSCCH information or the PSSCH information by the first terminal device and a start position of the first symbol.

In some other embodiments, the first terminal device shares the Channel Occupation Time (COT) initiated by the third terminal device, and the third terminal device initiates the COT after performing type1 LBT.

In a case where the first terminal device shares the Channel Occupation Time (COT) initiated by the third terminal device, the first terminal device and the third terminal device share a period of channel occupation time; or, the first terminal device, the third terminal device and other terminal devices sharing the COT initiated by the third terminal device share a period of channel occupation time.

In a case where the first terminal device shares the Channel Occupation Time (COT) initiated by the third terminal device, in an example, the first information is the PSCCH information or the PSSCH information. Correspondingly, the process of the second terminal device executing the step S1101 may be, for example, receiving the CPE in a third time interval before receiving the first symbol of the first information of the first terminal device, and the third time interval is a time interval between an end position of sending the PSCCH information or the PSSCH information by the third terminal device and a start position of the first symbol.

In another example, the first information is the PSFCH information. Correspondingly, the process of the second terminal device executing the step S1101 may be, for example, receiving the CPE in a fourth time interval before receiving the first symbol of the first information of the first terminal device, and the fourth time interval is a time interval between an end position of sending the PSCCH information or the PSSCH information by the third terminal device and a start position of the first symbol.

It should be noted that, during the channel occupation time, before the information of the first terminal device is sent, the information of the third terminal device may be sent, or the information of other terminal devices may be sent. For example, other terminal devices may be any terminal device other than the first terminal device that shares the COT initiated by the third terminal device.

In the method for receiving the Cyclic Prefix Extension (CPE) in embodiments of the present disclosure, the second terminal device receives the CPE sent by the first terminal device before receiving the first symbol of the first information of the first terminal device, the first information is the Physical Sidelink Control Channel (PSCCH) information, the Physical Sidelink Shared Channel (PSSCH) information, or the Physical Sidelink Feedback Channel (PSFCH) information, thereby ensuring that there is no idle time interval in the channel occupation time and ensuring the continuity of information transmission in the channel occupation time.

In the above-mentioned embodiments provided in the present disclosure, the methods provided in the embodiments of the present disclosure are introduced from the perspectives of the terminal device. In order to realize the various functions in the method provided by the above-mentioned embodiments of the present disclosure, the first terminal device may include a hardware structure and a software module, and realize the above-mentioned functions in the form of a hardware structure, a software module, or a hardware structure plus a software module. A certain function among the above-mentioned functions may be implemented in the form of a hardware structure, a software module, or a hardware structure plus a software module.

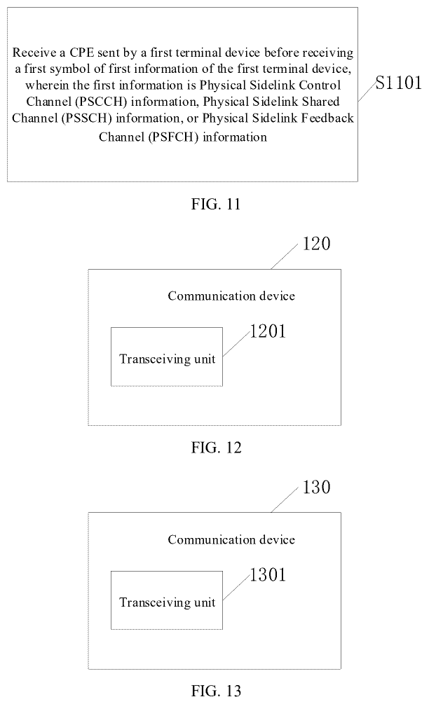

Please refer to FIG. 12, which is a schematic structural diagram of a first terminal device 120 provided in an embodiment of the present disclosure. The first terminal device 120 includes: a transceiving unit 1201, configured to send the CPE to a second terminal device before a first symbol of first information sent by the first terminal device, and the first information is Physical Sidelink Control Channel (PSCCH) information, Physical Sidelink Shared Channel (PSSCH) information, or Physical Sidelink Feedback Channel (PSFCH) information.

In an implementation, the first terminal device does not share a Channel Occupation Time (COT) initiated by a third terminal device.

In an implementation, the first information is the PSCCH information or the PSSCH information, and the transceiving unit 1201 is specifically configured to send the CPE in a first time interval before the first symbol of the first information sent by the first terminal device, and the first time interval is a time interval between an end position of performing LBT by the first terminal device and a start position of the first symbol.

In an implementation, the first information is the PSFCH information, and the transceiving unit 1201 is specifically configured to send the CPE in a second time interval before the first symbol of the first information sent by the first terminal device, and the second time interval is a time interval between an end position of sending the PSCCH information or the PSSCH information by the first terminal device and a start position of the first symbol.

In an implementation, the first terminal device shares the Channel Occupation Time (COT) initiated by the third terminal device, and the third terminal device initiates the COT after performing type1 LBT.

In an implementation, the first information is the PSCCH information or the PSSCH information, and the transceiving unit 1201 is specifically configured to send the CPE in a third time interval before the first symbol of the first information sent by the first terminal device, and the third time interval is a time interval between an end position of sending the PSCCH information or the PSSCH information by the third terminal device and a start position of the first symbol.

In an implementation, the first information is the PSFCH information, and the transceiving unit 1201 is specifically configured to send the CPE in a fourth time interval before the first symbol of the first information sent by the first terminal device, the fourth time interval is a time interval between an end position of sending the PSCCH information or the PSSCH information by the third terminal device and a start position of the first symbol.

Please refer to FIG. 13, which is a schematic structural diagram of a second terminal device 130 provided in an embodiment of the present disclosure. The second terminal device 130 includes a transceiving unit 1301, configured to receive the CPE sent by a first terminal device before receiving a first symbol of first information of the first terminal device, and the first information is Physical Sidelink Control Channel (PSCCH) information, Physical Sidelink Shared Channel (PSSCH) information, or Physical Sidelink Feedback Channel (PSFCH) information.

In an implementation, the first terminal device does not share a Channel Occupation Time (COT) initiated by a third terminal device.

In an implementation, the first information is the PSCCH information, or the PSSCH information, and the transceiving unit 1301 is specifically configured to receive the CPE in a first time interval before receiving the first symbol of the first information of the first terminal device, and the first time interval is a time interval between an end position of performing LBT by the first terminal device and a start position of the first symbol.

In an implementation, the first information is the PSFCH information, and the transceiving unit 1301 is specifically configured to receive the CPE in a second time interval before receiving the first symbol of the first information of the first terminal device, and the second time interval is a time interval between an end position of sending the PSCCH information or the PSSCH information by the first terminal device and a start position of the first symbol.

In an implementation, the first terminal device shares the Channel Occupation Time (COT) initiated by the third terminal device, and the third terminal device initiates the COT after performing type1 LBT.

In an implementation, the first information is the PSCCH information or the PSSCH information, and the transceiving unit 1301 is specifically configured to receive the CPE in a third time interval before receiving the first symbol of the first information of the first terminal device, and the third time interval is a time interval between an end position of sending the PSCCH information or the PSSCH information by the third terminal device and a start position of the first symbol.

In an implementation, the first information is the PSFCH information, and the transceiving unit 1301 is specifically configured to receive the CPE in a fourth time interval before receiving the first symbol of the first information of the first terminal device, and the fourth time interval is a time interval between an end position of sending the PSCCH information or the PSSCH information by the third terminal device and a start position of the first symbol.

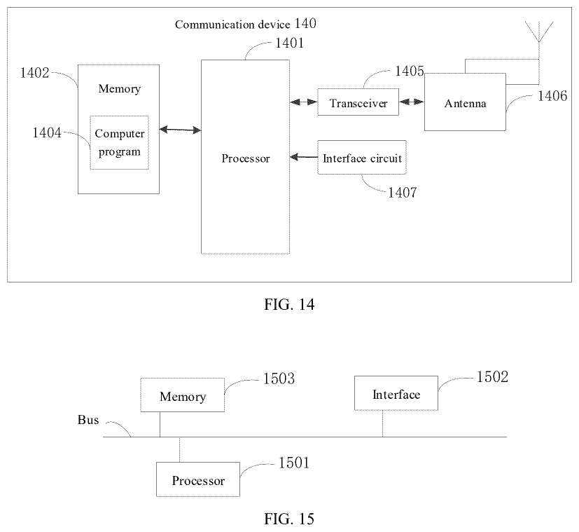

Please refer to FIG. 14, which is a schematic structural diagram of another communication device 140 provided in an embodiment of the present disclosure, the communication device 140 may be a terminal device (such as the first terminal device or the second terminal device in the aforementioned method embodiments), or a chip, a chip system, or a processor that supports the terminal device to implement the above methods. The communication device can be used to implement the methods described in the above method embodiments, and for details, the descriptions in the above method embodiments may be referred to.

The communication device 140 may include one or more processors 1401. The processor 1401 may be a general-purpose processor or a special-purpose processor or the like. For example, it can be a baseband processor or a central processing unit. The baseband processor can be used to process communication protocols and communication data, and the central processing unit can be used to control communication devices (such as base stations, baseband chips, terminal devices, terminal device chips, DUs or CUs, etc.), execute computer programs, and process data of computer programs.

In some embodiments of the present disclosure, the communication device 140 may further include one or more memories 1402, on which a computer program 1404 may be stored, and the processor 1401 executes the computer program 1404, so that the communication device 140 executes the method described in the above method embodiments. In some embodiments of the present disclosure, data may also be stored in the memory 1402. The communication device 140 and the memory 1402 can be set separately or integrated together.

In some embodiments of the present disclosure, the communication device 140 may further include a transceiver 1405 and an antenna 1406. The transceiver 1405 may be called a transceiving unit, a transceiver, or a transceiver circuit, etc., and is used to implement a transceiver function. The transceiver 1405 may include a receiver and a transmitter, and the receiver may be called a receiver or a receiving circuit for realizing a receiving function; the transmitter may be called a sender or a sending circuit for realizing a sending function.

In some embodiments of the present disclosure, the communication device 140 may further include one or more interface circuits 1407. The interface circuit 1407 is used to receive code instructions and transmit them to the processor 1401. The processor 1401 runs the code instructions to enable the communication device 140 to execute the methods described in the foregoing method embodiments.

The communication device 140 is a terminal device (such as the first terminal device in the foregoing method embodiments): the transceiver 1405 is configured to execute the step S201 in FIG. 2, execute the step S301 in FIG. 3, execute the step S501 in FIG. 5, execute the step S701 in FIG. 7, and execute the step S901 in FIG. 9.

The communication device 140 is a terminal device (such as the second terminal device in the foregoing method embodiments): the transceiver 1405 is configured to execute the step S1101 in FIG. 11.

In an implementation, the processor 1401 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The transceiver circuit, interface or interface circuit can be used for reading and writing codes/data, or the transceiver circuit, interface or interface circuit can be used for signal transmission or transfer.

In an implementation of the present disclosure, the processor 1401 may be stored with a computer program 1404, and the computer program 1404 is performed by the processor 1401, causing the communication device 140 to perform the method described in the above method embodiments. The computer program 1404 may be solidified in the processor 1401, in which case the processor 1401 may be implemented by hardware.

In an implementation of the present disclosure, the communication device 140 may include a circuit, and the circuit may implement the functions of sending or receiving or communicating in the foregoing method embodiments. The processors and transceivers described in the present disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication device described in the above embodiments may be the terminal device (e.g., the first terminal device and the second terminal device in the above method embodiments), but the scope of the communication device described in the present disclosure is not limited thereto, and the structure of the communication device may not be limited to FIG. 14. The communication device may be a stand-alone device or may be part of a larger device. For example, the communication device may be:
(1) a stand-alone integrated circuit IC, or chip, or chip system or subsystem;
(2) a set of one or more ICs. In embodiments of the present disclosure, the IC set may further include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network device, a cloud device, an artificial intelligence device, and the like;
(6) others, etc.

In a case that the communication device may be a chip or a system on a chip, reference may be made to a schematic structural diagram of a chip shown in FIG. 15. The chip shown in FIG. 15 includes a processor 1501 and an interface 1502. The number of processors 1501 may be one or more, and the number of interfaces 1502 may be multiple.

In an embodiment of the present disclosure, the chip further includes a memory 1503, and the memory 1503 is configured to store necessary computer programs and data.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure further provide a communication system, which includes the first terminal device in the embodiment of FIG. 12 and the second terminal device in the embodiment of FIG. 13.

The present disclosure further provides a readable storage medium on which instructions are stored. When the instructions are performed by a computer, the functions of any of the above method embodiments are implemented.

The present disclosure further provides a computer program product, which, when been performed by a computer, implements the functions of any of the above method embodiments.

Embodiments of the present disclosure provide a method and apparatus for sending a Cyclic Prefix Extension (CPE), which can be applied to the field of communication technologies to realize that the CPE is sent to a second terminal device before a first symbol of first information sent by a first terminal device, wherein the first information is Physical Sidelink Control Channel (PSCCH) information, Physical Sidelink Shared Channel (PSSCH) information, or Physical Sidelink Feedback Channel (PSFCH) information, so as to ensure the continuity of information transmission during the channel occupation time.

In a first aspect, embodiments of the present disclosure provide a method for sending a Cyclic Prefix Extension (CPE), which is performed by a first terminal device, and the method includes: sending the CPE to a second terminal device before a first symbol of first information sent by the first terminal device; wherein the first information is Physical Sidelink Control Channel (PSCCH) information, Physical Sidelink Shared Channel (PSSCH) information, or Physical Sidelink Feedback Channel (PSFCH) information.

In an implementation, the first information is the PSCCH information or the PSSCH information; sending the CPE to the second terminal device before the first symbol of the first information sent by the first terminal device includes: sending the CPE in a first time interval before the first symbol of the first information sent by the first terminal device; wherein the first time interval is a time interval between an end position of performing LBT by the first terminal device and a start position of the first symbol.

In an implementation, the first information is the PSFCH information; sending the CPE to the second terminal device before the first symbol of the first information sent by the first terminal device includes: sending the CPE in a second time interval before the first symbol of the first information sent by the first terminal device; wherein the second time interval is a time interval between an end position of sending the PSCCH information or the PSSCH information by the first terminal device and a start position of the first symbol.

In an implementation, a Channel Occupation Time (COT) initiated by a third terminal device is shared by the first terminal device, and the COT is initiated by the third terminal device after performing type1 LBT.

In an implementation, the first information is the PSCCH information or the PSSCH information; and sending the CPE to the second terminal device before the first symbol of the first information sent by the first terminal device includes: sending the CPE in a third time interval before the first symbol of the first information sent by the first terminal device; wherein the third time interval is a time interval between an end position of sending the PSCCH information or the PSSCH information by the third terminal device and a start position of the first symbol.

In an implementation, the first information is the PSFCH information; and sending the CPE to the second terminal device before the first symbol of the first information sent by the first terminal device includes: sending the CPE in a fourth time interval before the first symbol of the first information sent by the first terminal device; wherein the fourth time interval is a time interval between an end position of sending the PSCCH information or the PSSCH information by the third terminal device and a start position of the first symbol.

In a second aspect, embodiments of the present disclosure provide a method for receiving a Cyclic Prefix Extension (CPE), which is performed by a second terminal device, and the method includes: receiving the CPE sent by a first terminal device before receiving a first symbol of first information of the first terminal device; wherein the first information is Physical Sidelink Control Channel (PSCCH) information, Physical Sidelink Shared Channel (PSSCH) information, or Physical Sidelink Feedback Channel (PSFCH) information.

In an implementation, the first information is the PSCCH information or the PSSCH information; and receiving the CPE sent by the first terminal device before receiving the first symbol of the first information of the first terminal device includes: receiving the CPE in a first time interval before receiving the first symbol of the first information of the first terminal device; wherein the first time interval is a time interval between an end position of performing LBT by the first terminal device and a start position of the first symbol.

In an implementation, the first information is the PSFCH information; and receiving the CPE sent by the first terminal device before receiving the first symbol of the first information of the first terminal device includes: receiving the CPE in a second time interval before receiving the first symbol of the first information of the first terminal device; wherein the second time interval is a time interval between an end position of sending the PSCCH information or the PSSCH information by the first terminal device and a start position of the first symbol.

In an implementation, a Channel Occupation Time (COT) is initiated by a third terminal device after performing type1 LBT, and is shared by the first terminal device.

In an implementation, the first information is the PSCCH information or the PSSCH information; and receiving the CPE sent by the first terminal device before receiving the first symbol of the first information of the first terminal device includes: receiving the CPE in a third time interval before receiving the first symbol of the first information of the first terminal device; wherein the third time interval is a time interval between an end position of sending the PSCCH information or the PSSCH information by the third terminal device and a start position of the first symbol.

In an implementation, the first information is the PSFCH information; and receiving the CPE sent by the first terminal device before receiving the first symbol of the first information of the first terminal device includes: receiving the CPE in a fourth time interval before receiving the first symbol of the first information of the first terminal device; wherein the fourth time interval is a time interval between an end position of sending the PSCCH information or the PSSCH information by the third terminal device and a start position of the first symbol.

In a third aspect, embodiments of the present disclosure provide a first terminal device, which has some or all functions of the first terminal device in the method described in the first aspect above, for example, the functions of the first terminal device may have the functions of part or all of the embodiments in the present disclosure, or may have the function of independently implementing any one of the embodiments in the present disclosure. The functions described above may be implemented by hardware, or may be implemented by executing corresponding software on the hardware. The hardware or software includes one or more units or modules corresponding to the above functions.

In an implementation, the structure of the first terminal device may include a transceiving module and a processing module, and the processing module is configured to support the first terminal device to perform corresponding functions in the foregoing method. The transceiving module is configured to support communication between the first terminal device and other device(s). The first terminal device may further include a storage module, which is configured to be coupled with the transceiving module and the processing module, and store necessary computer programs and data of the first terminal device.

As an example, the processing module may be a processor, the transceiving module may be a transceiver or a communication interface, and the storage module may be a memory.

In a fourth aspect, embodiments of the present disclosure provide a second terminal device, which has some or all functions of the second terminal device in the method described in the second aspect above, for example, the functions of the second terminal device may have the functions of part or all of the embodiments in the present disclosure, or may have the function of independently implementing any one of the embodiments in the present disclosure. The functions described above may be implemented by hardware, or may be implemented by executing corresponding software on the hardware. The hardware or software includes one or more units or modules corresponding to the above functions.

In an implementation, the structure of the second terminal device may include a transceiving module and a processing module, and the processing module is configured to support the second terminal device to perform corresponding functions in the foregoing method. The transceiving module is configured to support communication between the second terminal device and other device(s). The second terminal device may further include a storage module, which is configured to be coupled with the transceiving module and the processing module, and store necessary computer programs and data of the second terminal device.

As an example, the processing module may be a processor, the transceiving module may be a transceiver or a communication interface, and the storage module may be a memory.

In a fifth aspect, embodiments of the present disclosure provide a communication device, including a processor, and when the processor invokes a computer program in a memory, it executes the method described in the first aspect above.

In a sixth aspect, embodiments of the present disclosure provide a communication device, including a processor, and when the processor invokes a computer program in a memory, it executes the method described in the second aspect above.

In a seventh aspect, embodiments of the present disclosure provide a communication device, including a processor and a memory, and a computer program is stored in the memory; the processor executes the computer program stored in the memory, so that the communication device executes the method described in the first aspect above.

In an eighth aspect, embodiments of the present disclosure provide a communication device, including a processor and a memory, and a computer program is stored in the memory; the processor executes the computer program stored in the memory, so that the communication device executes the method described in the second aspect above.

In a ninth aspect, embodiments of the present disclosure provide a communication device, including a processor and an interface circuit, the interface circuit is configured to receive code instructions and send them to the processor, and the processor is configured to run the code instructions to cause the communication device to execute the method described in the first aspect above.

In a tenth aspect, embodiments of the present disclosure provide a communication device, including a processor and an interface circuit, the interface circuit is configured to receive code instructions and send them to the processor, and the processor is configured to run the code instructions to cause the communication device to execute the method described in the second aspect above.

In an eleventh aspect, embodiments of the present disclosure provide a communication system, which includes the first terminal device described in the third aspect and the second terminal device described in the fourth aspect, or, the system includes the communication device described in the fifth aspect and the communication device described in the sixth aspect, or, the system includes the communication device described in the seventh aspect and the communication device described in the eighth aspect, or, the system includes the communication device described in the ninth aspect and the communication device described in the tenth aspect.

In a twelfth aspect, embodiments of the present disclosure provide a computer-readable storage medium, which is configured to store instructions used by the above-mentioned terminal device, and the instructions, when executed, cause the terminal device to execute the method described in the above-mentioned first aspect.

In a thirteenth aspect, embodiments of the present disclosure provide a computer-readable storage medium, which is configured to store instructions used by the above-mentioned terminal device, and the instructions, when executed, cause the terminal device to execute the method described in the above-mentioned second aspect.

In a fourteenth aspect, the present disclosure further provides a computer program product including a computer program, which, when run on a computer, causes the computer to execute the method described in the above-mentioned first aspect.

In a fifteenth aspect, the present disclosure further provides a computer program product including a computer program, which, when run on a computer, causes the computer to execute the method described in the above-mentioned second aspect.

In a sixteenth aspect, the present disclosure provides a chip system, including at least one processor and an interface, and configured to support the terminal device to implement the functions involved in the first aspect, for example, determine or process at least one of data or information involved in the above method. In a possible design, the chip system further includes a memory, and the memory is configured to store necessary computer programs and data of the terminal device. The chip system may consist of chips, or may include a chip and other discrete device(s).

In a seventeenth aspect, the present disclosure provides a chip system, including at least one processor and an interface, and configured to support the terminal device to implement the functions involved in the second aspect, for example, determine or process at least one of data or information involved in the above method. In a possible design, the chip system further includes a memory, and the memory is configured to store necessary computer programs and data of the terminal device. The chip system may consist of chips, or may include a chip and other discrete device(s).

In an eighteenth aspect, the present disclosure provides a computer program which, when run on a computer, causes the computer to execute the method described in the first aspect above. In a nineteenth aspect, the present disclosure provides a computer program which, when run on a computer, causes the computer to execute the method described in the second aspect above.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in the present disclosure are only distinctions made for convenience of description and are not used to limit the scope of the embodiments of the disclosure, nor to indicate the order.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

The corresponding relationships shown in the tables in the present disclosure can be configured or predefined. The values of the information in each table are just examples, and may be configured as other values, which are not limited in the present disclosure. When configuring the corresponding relationship between the information and each parameter, it is not necessarily required to configure all the corresponding relationships shown in the tables. For example, in the table in the present disclosure, the corresponding relationship shown in some rows may not be configured. For another example, appropriate deformation adjustments can be made based on the above tables, for example, splitting, merging, and so on. The names of the parameters shown in the titles of the above tables may also adopt other names understandable by the communication device, and the values or representations of the parameters may also be other values or representations understandable by the communication device. When the above tables are implemented, other data structures can also be used, for example, arrays, queues, containers, stacks, linear tables, pointers, linked lists, trees, graphs, structures, classes, heaps, hashtables or hash tables.

The predefining in the present disclosure can be understood as defining, defining in advance, storing, pre-storing, pre-negotiating, pre-configuring, curing, or pre-firing.

Those skilled in the art can appreciate that the units and algorithm steps of the examples described in conjunction with the embodiments disclosed herein can be implemented by an electronic hardware, or a combination of computer software and the electronic hardware. Whether these functions are executed by hardware or software depends on the specific application and design constraints of the technical solution. Skilled artisans may implement the described functions using different methods for each particular application, but such implementation should not be considered as going beyond the scope of the present disclosure.

Those skilled in the art can clearly understand that for the convenience and brevity of the description, the specific working process of the above-described system, apparatus and unit may refer to the corresponding process in the foregoing method embodiments, which will not be repeated here.

The above is only the specific implementation of the present disclosure, and the scope of protection of the present disclosure is not limited thereto. Anyone skilled in the art can easily think of changes or substitutions within the technical scope of the present disclosure, which should fall within the protection scope of the present disclosure. Therefore, the protection scope of the present disclosure should be determined by the protection scope of the claims.

1. A method for sending a Cyclic Prefix Extension (CPE), performed by a first terminal device, and comprising:
sending the CPE to a second terminal device before a first symbol of first information sent by the first terminal device;
wherein the first information is Physical Sidelink Control Channel (PSCCH) information, Physical Sidelink Shared Channel (PSSCH) information, or Physical Sidelink Feedback Channel (PSFCH) information.

2. The method according to claim 1, wherein sending the CPE to the second terminal device before the first symbol of the first information sent by the first terminal device comprises:
sending the CPE in a first time interval before the first symbol of the first information sent by the first terminal device;
wherein the first time interval is a time interval between an end position of performing LBT by the first terminal device and a start position of the first symbol, and the first information is the PSCCH information or the PSSCH information.

3. The method according to claim 1, wherein sending the CPE to the second terminal device before the first symbol of the first information sent by the first terminal device comprises:
sending the CPE in a second time interval before the first symbol of the first information sent by the first terminal device;
wherein the second time interval is a time interval between an end position of sending the PSCCH information or the PSSCH information by the first terminal device and a start position of the first symbol, and the first information is the PSFCH information.

4. The method according to claim 1, wherein a Channel Occupation Time (COT) initiated by a third terminal device is shared by the first terminal device, and the COT is initiated by the third terminal device after performing type1 LBT.

5. The method according to claim 4, wherein sending the CPE to the second terminal device before the first symbol of the first information sent by the first terminal device comprises:
sending the CPE in a third time interval before the first symbol of the first information sent by the first terminal device;
wherein the third time interval is a time interval between an end position of sending the PSCCH information or the PSSCH information by the third terminal device and a start position of the first symbol, and the first information is the PSCCH information or the PSSCH information.

6. The method according to claim 4, wherein sending the CPE to the second terminal device before the first symbol of the first information sent by the first terminal device comprises:
sending the CPE in a fourth time interval before the first symbol of the first information sent by the first terminal device;
wherein the fourth time interval is a time interval between an end position of sending the PSCCH information or the PSSCH information by the third terminal device and a start position of the first symbol, and the first information is the PSFCH information.

7. A method for receiving a Cyclic Prefix Extension (CPE), performed by a second terminal device, and comprising:
receiving the CPE sent by a first terminal device before receiving a first symbol of first information of the first terminal device;
wherein the first information is Physical Sidelink Control Channel (PSCCH) information, Physical Sidelink Shared Channel (PSSCH) information, or Physical Sidelink Feedback Channel (PSFCH) information.

8. The method according to claim 7, wherein receiving the CPE sent by the first terminal device before receiving the first symbol of the first information of the first terminal device comprises:
receiving the CPE in a first time interval before receiving the first symbol of the first information of the first terminal device;
wherein the first time interval is a time interval between an end position of performing LBT by the first terminal device and a start position of the first symbol, and the first information is the PSCCH information or the PSSCH information.

9. The method according to claim 7, wherein receiving the CPE sent by the first terminal device before receiving the first symbol of the first information of the first terminal device comprises:
receiving the CPE in a second time interval before receiving the first symbol of the first information of the first terminal device;
wherein the second time interval is a time interval between an end position of sending the PSCCH information or the PSSCH information by the first terminal device and a start position of the first symbol, and the first information is the PSFCH information.

10. The method according to claim 7, wherein a Channel Occupation Time (COT) is initiated by a third terminal device after performing type1 LBT, and is shared by the first terminal device.

11. The method according to claim 10, wherein receiving the CPE sent by the first terminal device before receiving the first symbol of the first information of the first terminal device comprises:
receiving the CPE in a third time interval before receiving the first symbol of the first information of the first terminal device;
wherein the third time interval is a time interval between an end position of sending the PSCCH information or the PSSCH information by the third terminal device and a start position of the first symbol, and the first information is the PSCCH information or the PSSCH information.

12. The method according to claim 10, wherein receiving the CPE sent by the first terminal device before receiving the first symbol of the first information of the first terminal device comprises:
receiving the CPE in a fourth time interval before receiving the first symbol of the first information of the first terminal device;
wherein the fourth time interval is a time interval between an end position of sending the PSCCH information or the PSSCH information by the third terminal device and a start position of the first symbol, and the first information is the PSFCH information.

13-14. (canceled)

15. A first terminal device, comprising a processor and a memory, wherein a computer program is stored in the memory, and the processor is configured to executes the computer program stored in the memory to cause the communication device to execute the following operations:
sending a Cyclic Prefix Extension (CPE) to a second terminal device before a first symbol of first information sent by the first terminal device;
wherein the first information is Physical Sidelink Control Channel (PSCCH) information, Physical Sidelink Shared Channel (PSSCH) information, or Physical Sidelink Feedback Channel (PSFCH) information.

16. A second terminal device, comprising a processor and a memory, wherein a computer program is stored in the memory, and the processor is configured to execute the computer program stored in the memory to cause the communication device to execute the method according to claim 7.

17. A communication device, comprising a processor and an interface circuit; wherein:
the interface circuit is configured to receive code instructions and send the code instructions to the processor; and
the processor is configured to run the code instructions to execute the method according to any claim 1.

18. A communication device, comprising a processor and an interface circuit; wherein:
the interface circuit is configured to receive code instructions and send the code instructions to the processor; and
the processor is configured to run the code instructions to execute the method according to claim 7.

19. A non-transitory computer-readable storage medium having instructions store thereon which, when executed, cause the method according to claim 1 to be implemented.

20. A non-transitory computer-readable storage medium having instructions store thereon which, when executed, cause the method according to claim 7 to be implemented.

21. The first terminal device according to claim 15, wherein the processor is further configured to:
send the CPE in a first time interval before the first symbol of the first information sent by the first terminal device;
wherein the first time interval is a time interval between an end position of performing LBT by the first terminal device and a start position of the first symbol, and the first information is the PSCCH information or the PSSCH information.

22. The first terminal device according to claim 15, wherein the processor is further configured to:
send the CPE in a second time interval before the first symbol of the first information sent by the first terminal device;
wherein the second time interval is a time interval between an end position of sending the PSCCH information or the PSSCH information by the first terminal device and a start position of the first symbol, and the first information is the PSFCH information.
